(19) United States
(12) Patent Application Publication
(10) Pub. No.: US 2014/0165367 A1
(43) Pub. Date: Jun. 19, 2014

(54) Screw Attachment Plug And Method Of Using The Same

(71) Applicant: Diversified Structural Composites, Inc., Erlanger, KY (US)

(72) Inventors: Mark A. Back, Myrtle Beach, SC (US); Geoffrey C. Card, Venice, FL (US)

(73) Assignee: DIVERSIFIED STRUCTURAL COMPOSITES, INC., Erlanger, KY (US)

(21) Appl. No.: 14/023,992

(22) Filed: Sep. 11, 2013

Related U.S. Application Data
(60) Provisional application No. 61/699,669, filed on Sep. 11, 2012.

(51) Int. Cl. F16B 21/10

(52) U.S. Cl. CPC F16B 21/10
USPC 29/525.02; 411/55

(57) ABSTRACT

A screw attachment plug includes a proximal portion having a first diameter and a first height, a middle portion having a second, constant diameter, a second height and a means for preventing rotation of the plug relative to the substrate and the portion. The screw attachment also includes a distal portion including a distal end, proximal end, and an outer surface therebetween. The plug includes a bore through the proximal, middle and distal portions adapted to receive a screw and a plurality of slots in the distal section, each defined by an open space between the outer surface and the bore thereby separating the distal portion into a plurality of sections. The open spaces are adapted to expand when a screw is inserted into the bore to thereby expand at least the middle and distal portions within the substrate.

### TECHNICAL FIELD

This disclosure generally relates to hardware used in affixing items to walls or other substrates or structures.

### BACKGROUND

It is often very difficult to fix thin pieces of material to a substrate, such as a piece of plywood or drywall. This is due to the thin nature of the material being fixed and its inability to accept threads of a screw or other types of fasteners. The devices in the prior art do not solve this problem.

### SUMMARY

It is therefore an object of the present invention to provide a screw attachment plug for use when a thin piece of material, such as fiberglass, must be fixed to a substrate. It is a further object of the present invention to provide a screw attachment plug for use in multiple applications where a thin piece of material must be fixed to a substrate, providing both a functional and aesthetic value. Yet another object of this invention is to provide a method of fixing a thin piece of material to a substrate.

### BRIEF DESCRIPTION

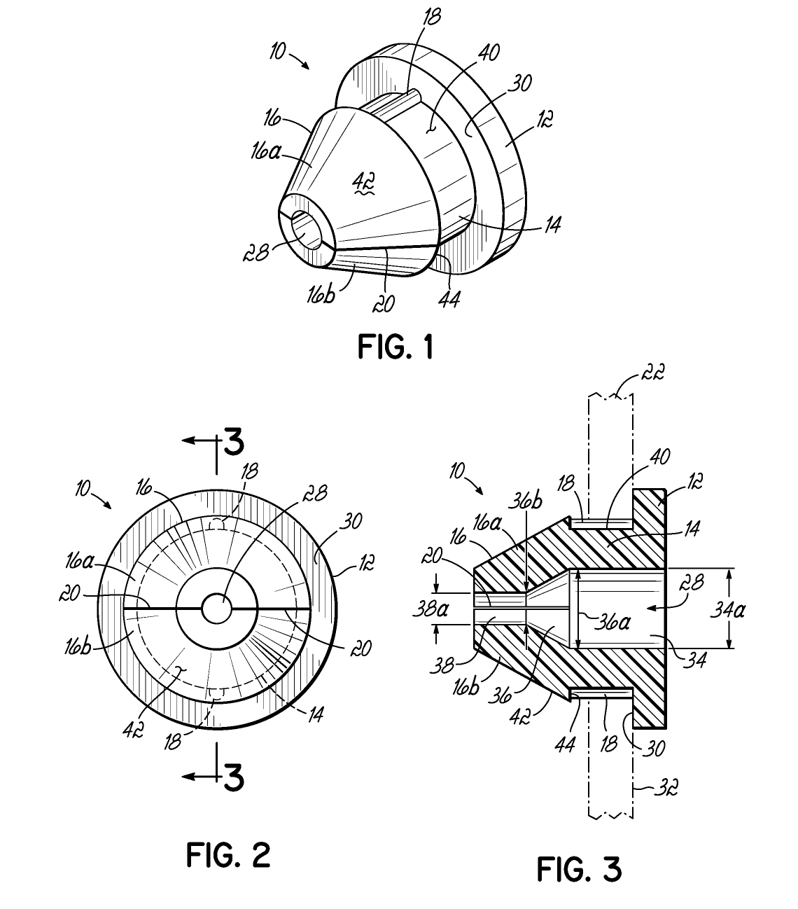

FIG. 1 is a front perspective view of the screw attachment plug in a preferred embodiment.

FIG. 2 is a front view of the screw attachment plug.

FIG. 3 is a cross-sectional view of the screw attachment plug taken along line 3-3 of FIG. 2, as inserted through a portion of thin material.

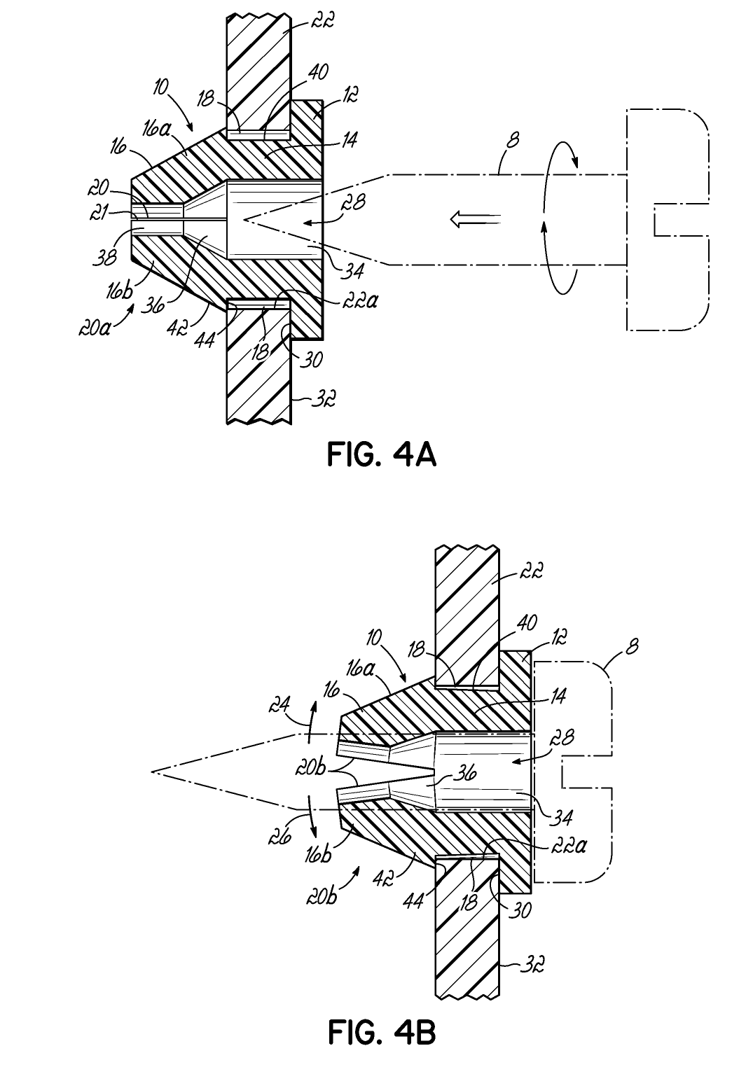

FIG. 4A shows a cross-sectional view of the screw attachment plug as inserted through a portion of thin material.

FIG. 4B shows a cross-sectional view of the screw attachment plug as inserted through a portion of thin material with a screw inserted into the screw attachment plug.

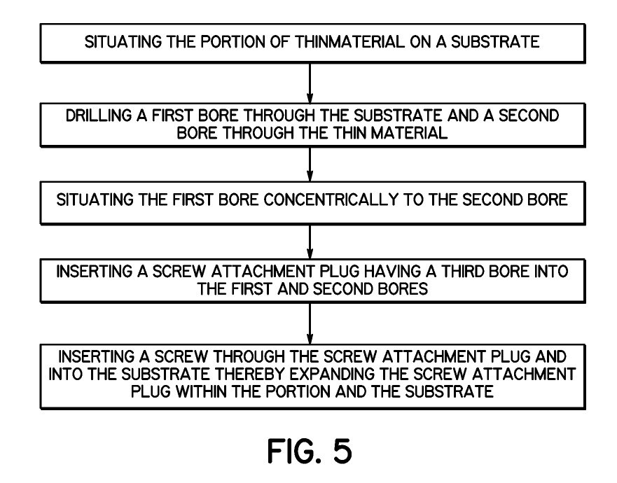

FIG. 5 shows a flow chart showing steps of one method of fixing a portion of thin material to a substrate.

### DETAILED DESCRIPTION

With reference to FIGS. 1-3, screw attachment plug 10 includes a proximal portion 12 generally cylindrically shaped, a middle portion 14 generally cylindrically shaped, and a distal portion 16 generally frustroconically shaped. The screw attachment plug has a bore 28 through the proximal, middle, and distal portions 12, 14 and 16. In alternate embodiments, proximal and middle portions 12, 14 may be a shape different than cylindrical and distal portion may be a shape other than frustroconical. For example, the distal portion could be the shape of a multi-point frustrum, such as a hexagonal, pentagonal, or octagonal frustrum.

The bore 28 in a preferred embodiment, as can be seen in FIGS. 3, 4A, and 4B, has three sections 34, 36, and 38. First section 34 of bore 28 has a first diameter 34a. Second section 36 of bore 28 has a second and third diameter 36a and 36b, thereby defining a frustroconical shape. Third section 38 of bore 28 has a fourth diameter 38a, which in one embodiment is smaller than the first diameter 34a and second diameter 36a, but equal to the third diameter 36b. In alternative embodiments, the bore 28 may have one diameter throughout the entire length of the bore 28 or have different configurations, such as the second section 36 being a shape other than frustroconical.

The middle portion 14 has at least one rib 18 radially extending from the outer surface 40. In a preferred embodiment, there are two ribs 18 which are diametrically opposed and radially extending from the outside surface 40. In other embodiments, there may be more than two ribs 18 that may be spaced evenly apart on outside surface 40. Alternatively, the arrangement and placement of the ribs 18 on the outer surface 40 may be uneven and asymmetric. When the screw attachment plug is inserted through a thin piece of material 22 such as fiberglass, and into a bore 28 in a substrate material such as wood (not shown), the ribs 18 resist rotational movement of the screw attachment plug 10 with respect to thin material 22 and the substrate (not shown). In a preferred embodiment, the ribs 18 are of a substantially half-cylindrical shape extending radially from the outer surface 40. Alternatively, the ribs could be differently shaped and include, for example, rectangular features extending radially from the outside surface 40.

With continued reference to FIGS. 1-3, the distal portion 16 of the screw attachment plug 10 is generally frustroconically shaped. At least one slot 20 is disposed at the distal portion 16. In a preferred embodiment, there are two slots 20 which are diametrically opposed. Each slot 20 is defined by an open space between the outer surface 40 of the distal portion 16 and the bore 28, thereby separating the distal portion 16 into a plurality of sections 16a and 16b. In a preferred embodiment, there are two slots 20. Alternatively, there may be more than two slots 20, such as three or more, which would also increase the amount of sections 16a, 16b.

Referring to FIGS. 4A and 4B, when the screw attachment plug 10 is inserted into a thin piece of material 22 and into a bore in a substrate (such as wood, not pictured) the distal surface 30 of the proximal portion 12 may engage with the outer wall 32 of the thin piece of material 22. This engagement prevents the screw attachment plug 10 from traveling any further distally with respect to the thin piece of material 22 and assists in fixing the screw attachment plug 10 when a screw 8 (shown in phantom) is inserted in and through the bore 28 to the substrate (not shown).

Screw 8 may be inserted into bore 28. The diameter of screw 8 may be slightly larger than all sections 34, 36, 38 of bore 28, but the material of screw attachment plug will allow the screw to pass through bore 8. Additionally, the open spaces 21 of slots 20 may expand from closed position 20a into open position 20b, causing at least the middle portion 14 to expand within the piece of thin material 22 and the substrate (not shown) and causing the sections 16a, 16b to expand within the substrate in the directions indicated by arrows 24 and 26, respectively.

The screw attachment plug 10 in one embodiment is adapted for use with thin pieces of material 22 having thicknesses between approximately 0.050″ and approximately 0.100″. In other embodiments, the screw attachment plug 10 may be used with thinner or thicker materials, depending in part on the distance between the distal surface 30 of the proximal portion 12 and the proximal surface 44 of distal portion 16 and on the characteristics of the material of manufacture, among other things.

In one embodiment, the thin material 22 is fiberglass, but in other embodiments, it may be vinyl, a thermoplastic, or any other suitable material with similar desired properties as those of fiberglass.

The screw attachment plug 10 is preferably manufactured through an injection molding process well known in the art. Alternatively, the screw attachment plug 10 may be manufactured in another process suitable for the specifications, dimensions and material selection. For example, the screw attachment plug 10 may be injection molded without the bore 28, then the bore 28 may be formed by a milling process. The screw attachment plug can be comprised of a thermoplastic material such as Polyvinyl Chloride. Alternatively, the screw attachment plug may be comprised of alternative thermoplastic or thermoset materials with the desired characteristics.

With reference to FIG. 5, a method of fixing a portion of thin material to a substrate is also provided. The method comprises situating the portion of thin material on a substrate, drilling a first bore through the substrate and a second bore through the thin material, situating the first bore concentrically to the second bore and inserting a screw attachment plug having a third bore into the first and second bores. A screw is inserted through the screw attachment plug and into the substrate thereby expanding the screw attachment plug within the portion and the substrate, thereby fixing the portion relative to at least one axis of the substrate. In one preferred embodiment, the screw is inserted using a screwdriver. In one preferred embodiment, the thin portion of material is fiberglass, but may be other materials with similar desired characteristics, such as vinyl.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

What is claimed is:

1. A screw attachment plug for fixing a portion of thin material to a substrate, comprising:
a proximal portion;
a middle portion, at least one rib extending radially from the middle portion;
a distal portion having a generally frustroconical shape, an outer surface of the distal portion defining the generally frustroconical shape,
a bore through the proximal, middle, and distal portions, the bore adapted to receive a screw; and
at least one slot in the distal section, the at least one slot defined by at least one open space between the outer surface and the bore thereby separating the distal portion into a plurality of sections, wherein the open spaces are adapted to expand when a screw is inserted into the bore to thereby expand at least the middle and distal portions within the substrate.

2. The screw attachment plug of claim 1, wherein the at least one rib is adapted for preventing rotation of the plug relative to the substrate.

3. The screw attachment plug of claim 2, comprising first and second ribs extending radially from the middle portion.

4. The screw attachment plug of claim 3, wherein the first and second ribs are diametrically opposed.

5. The screw attachment plug of claim 1, wherein the middle portion has a second diameter, the proximal portion has a first diameter, the first diameter being greater than the second diameter.

6. The screw attachment plug of claim 1, wherein the plurality of slots includes first and second diametrically opposed slots thereby separating the distal portion into two sections.

7. The screw attachment plug of claim 1, wherein the plug comprises a thermoset or thermoplastic material.

8. The screw attachment plug of claim 7, wherein the plug comprises polyvinyl chloride.

9. The screw attachment plug of claim 1, wherein the portion of thin material comprises fiberglass.

10. The screw attachment plug of claim 1, wherein the portion of thin material has a thickness of between approximately 0.050 inches and approximately 0.100 inches.

11. A screw attachment plug for fixing a portion of thin material to a substrate, comprising:
a proximal portion having a first diameter;
a middle portion having a second diameter, at least one rib extending radially from the middle portion, the at least one rib adapted to prevent rotation of the plug relative to the substrate and the portion of thin material;
a distal portion including a front end having a third diameter, a back end having a fourth diameter, and an outer surface therebetween, the fourth diameter being greater than the third diameter and thereby defining the distal portion as an essentially frustroconical shape;
a bore through the proximal, middle and distal portions adapted to receive a screw; and
a plurality of slots in the distal section, each defined by an open space between the outer surface and the bore thereby separating the distal portion into a plurality of sections, wherein the open spaces are adapted to expand when a screw is inserted into the bore to thereby expand at least the middle and distal portions.

12. The screw attachment plug of claim 11 comprising first and second ribs extending radially from the middle portion.

13. The screw attachment plug of claim 12 wherein the first and second ribs are diametrically opposed.

14. The screw attachment plug of claim 11 where the portion of thin material is fiberglass.

15. A method of fixing a portion of thin material having a first bore to a substrate having a second bore, comprising:
situating the portion of thin material on a substrate such that the first and second bores are concentrically situated;
inserting a screw attachment plug having a third bore into the first and second bores; and
inserting a screw into the third bore of the screw attachment plug and into the substrate thereby expanding the screw attachment plug within the portion and the substrate, thereby fixing the portion relative to at least one axis of the substrate.

16. The method of claim 15, further comprising:
creating the first bore in the substrate and creating the second bore in the thin material.

17. The method of claim 15, wherein the portion of thin material includes a front surface and a back surface, the back surface substantially contacting the substrate and the screw attachment plug further comprises:
(i) a proximal portion with a second diameter, the second diameter greater than the first diameter and having a distal surface configured to engage the front surface when the screw plug is inserted into the first bore,
(ii) a middle portion having a third diameter and including at least one rib adapted to prevent rotation relative to the portion of thin material and the substrate, and
(iii) a distal portion including a distal end, proximal end, and an outer surface therebetween,
(iv) a second bore through the proximal, middle and distal portions adapted to receive a screw, and
(v) at least one slot in the distal section, each defined by an open space between the outer surface and the bore thereby separating the distal portion into a plurality of sections; and
(d) inserting a screw into the second bore and into the substrate, thereby expanding the sections within the substrate and fixing the portion of thin material to the substrate.

18. The method of claim 15, wherein the step of inserting a screw involves using a screwdriver to insert the screw.

19. The method of claim 16, wherein the step of inserting a screw involves using a screwdriver to insert the screw.

20. The method of claim 15, wherein the portion of thin material is fiberglass.
